(19) United States
(12) Patent Application Publication
(10) Pub. No.: US 2016/0148402 A1
(43) Pub. Date: May 26, 2016

(54) METHOD AND SYSTEM FOR EXTRANEOUS OBJECT NOTIFICATION INTERFACE IN MOBILE DEVICE OPERATION

(71) Applicant: Kobo Incorporated, Toronto (CA)

(72) Inventor: Benjamin LANDAU, Toronto (CA)

(73) Assignee: Kobo Incorporated, Toronto (CA)

(21) Appl. No.: 14/550,817

(22) Filed: Nov. 21, 2014

(51) Int. Cl. G06T 11/20; G06F 3/041

(52) U.S. Cl. CPC G06T 11/203; G06F 3/0412; G06T 2215/16; G06T 2207/10004; G06T 2207/20012

(57) ABSTRACT

A method and system for notifying an observer of the presence of one or more extraneous objects on a touchscreen display of a mobile computing device. The method is executed in a processor of the mobile computing device, the device including a memory storing instructions, a display screen including a set of touch sensors, the processor being capable of inferring a presence of an extraneous object on the display screen based on an interaction with the set of touch sensors, the method comprising determining a spatial area around an interaction in response to an inference that an extraneous object is present on the display screen; rendering a perimeter of the spatial area, the perimeter being superposed over an underlying text content portion shown on the display screen; and displaying a notification indicator configured to include the boundary and the underlying text content portion.

### TECHNICAL FIELD

Examples described herein relate to a system and method for transitioning a mobile computing device to operation in an alternate interface mode.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from or coupled to but distinct from the electronic personal display itself Some examples of electronic personal displays include mobile digital devices/tablet computers and electronic readers (e-readers) such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Kobo Aura H2O and the like).

Some electronic personal display devices are purpose built devices designed to perform especially well at displaying digitally stored content for reading or viewing thereon. For example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

There are also numerous kinds of consumer devices that can receive services and resources from a network service. Such devices can operate applications or provide other functionality that links a device to a particular account of a specific service. For example, the electronic reader (e-reader) devices typically link to an online bookstore, and media playback devices often include applications that enable the user to access an online media electronic library (or e-library). In this context, the user accounts can enable the user to receive the full benefit and functionality of the device.

As mobile computing devices having functionality for e-reading proliferate, users find it beneficial to be able to operate such devices in many varied surroundings to continue reading their favorite e-book, such as for example, at the beach, at poolside, and the like.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates a system utilizing applications and providing e-book services on a mobile computing device for operation with an extraneous object notification interface, according to an embodiment.

FIG. 2 illustrates a schematic configuration of a mobile computing device configured with an extraneous object notification interface, according to an embodiment.

FIGS. 3(a)-(c) illustrate example configurations of an extraneous object notification interface for operating a mobile computing device, according to some embodiments.

FIG. 4 illustrates a method of operating a computing device including an extraneous object notification interface, according to an embodiment.

### DETAILED DESCRIPTION

Embodiments described herein provide for a computing device that is operable even when water and/or other persistent objects are present on the surface of a display of the computing device. More specifically, the computing device may detect a presence of extraneous objects (e.g., such as water, dirt, or debris) on a surface of the display screen, and concisely but unobtrusively notify the observer or reader to perform one or more operations to mitigate or overcome the presence of such extraneous objects in order to maintain a functionality for use as intended, and/or to maintain viewability of content displayed on the display screen. For example, upon detecting the presence of one or more extraneous objects, such as water droplets, debris or dirt, such a notification interface could be invoked.

Embodiments described herein provide for a computing device that can detect the presence of water and debris (or other persistent objects) on the surface of a display of the computing device. More specifically, the computing device may determine that the surface of the display is wet based on the detection of a plurality of interactions with touch sensors provided with the display. For example, the computing device may determine that the display surface is wet if multiple interactions (e.g., three or more touch-based contacts) are detected, concurrently, and at least one of the interactions is a persistent interaction (e.g., contact with at least one of the touch sensors is continuously maintained for a threshold duration). The computing device may respond to water detection, for example, by adjusting one or more device settings, for example, a display state, device configurations and notifications and/or input responses.

“E-books” are a form of electronic publication content stored in digital format in a computer non-transitory memory, viewable on a computing device with suitable functionality. An e-book can correspond to, or mimic, the paginated format of a printed publication for viewing, such as provided by printed literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., specialized e-reading application software) to view e-books in a format that mimics the paginated printed publication. Still further, some devices (sometimes referred to as “e-readers”) can display digitally-stored content in a more reading-centric manner, while also providing, via a user input interface, the ability to manipulate that content for viewing, such as via discrete successive pages.

An “e-reading device”, also referred to herein as an electronic personal display, can refer to any computing device that can display or otherwise render an e-book. By way of example, an e-reading device can include a mobile computing device on which an e-reading application can be executed to render content that includes e-books (e.g., comic books, magazines, etc.). Such mobile computing devices can include, for example, a multi-functional computing device for cellular telephony/messaging (e.g., feature phone or smart phone), a tablet computer device, an ultra=mobile computing device, or a wearable computing device with a form factor of a wearable accessory device (e.g., smart watch or bracelet, glass-wear integrated with a computing device, etc.). As another example, an e-reading device can include an e-reader device, such as a purpose-built device that is optimized for an e-reading experience (e.g., with E-ink displays).

### System and Hardware Description

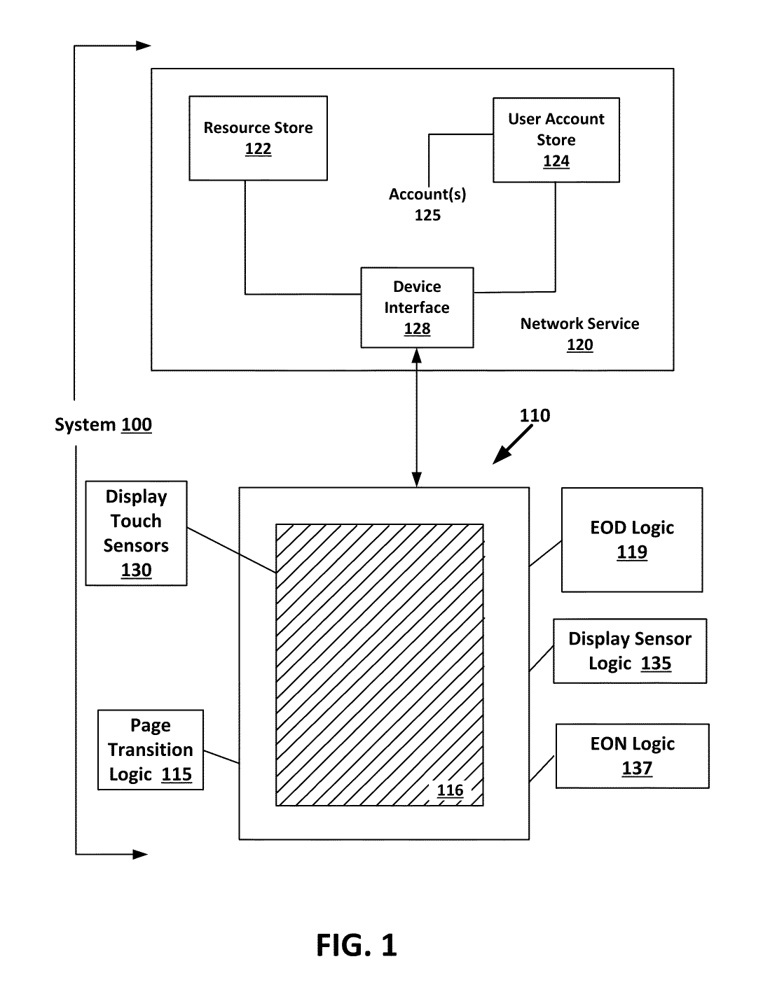

FIG. 1 illustrates a system 100 for utilizing applications and providing e-book services on a computing device, according to an embodiment. In an example of FIG. 1, system 100 includes an electronic personal display device, shown by way of example as an e-reading device 110, and a network service 120. The network service 120 can include multiple servers and other computing resources that provide various services in connection with one or more applications that are installed on the e-reading device 110. By way of example, in one implementation, the network service 120 can provide e-book services in communication with e-reading device 110. The e-book services provided through network service 120 can, for example, include services in which e-books are sold, shared, downloaded or stored. More generally, the network service 120 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can run an e-reader application that links the device to the network service 120 and enables e-books provided through the service to be viewed and consumed. In another implementation, the e-reading device 110 can run a media playback or streaming application that receives files or streaming data from the network service 120. By way of example, the e-reading device 110 can be equipped with hardware and software to optimize certain application activities, such as reading electronic content (e.g., e-books). For example, the e-reading device 110 can have a tablet-like form factor, although variations are possible. In some cases, the e-reading device 110 can also have an e-ink display.

In additional detail, the network service 120 can include a device interface 128, a resource store 122 and a user account store 124. User account store 124 can associate e-reading device 110 with a user and with account 125. Account 125 can also be associated with one or more application resources (e.g., e-books), which can be stored in the resource store 122, comprising an electronic library (e-library) of stored digital content. The device interface 128 can handle requests from the e-reading device 110, and further interface the requests of the device with services and functionality of the network service 120. The device interface 128 can utilize information provided with user account 125 in order to enable services, such as purchasing downloads of content or determining what e-books and content items are associated with the user device. Additionally, the device interface 128 can provide the e-reading device 110 with access to the content store 122, which can include, for example, an online store. The device interface 128 can handle input to identify content items (e.g., e-books), and further to link content items to the account 125 of the user.

Yet further, the user account store 124 can retain metadata for individual accounts 125 to identify resources or content that have been purchased or made available for consumption for a given account. The e-reading device 110 may be associated with the user account 125, and multiple devices may be associated with the same account. As described in greater detail below, the e-reading device 110 can store resources (e.g., e-books) that are purchased or otherwise made available to the user of the e-reading device 110, as well as to archive e-books and other digital content items that have been purchased for the user account 125, but are not stored on the particular computing device.

With reference to an example of FIG. 1, e-reading device 110 can include a display screen 116. In an embodiment, display screen 116 is touch-sensitive, to process touch inputs including gestures (e.g., swipes). For example, the display screen 116 may be integrated with one or more touch sensors 130 to provide a touch-sensing region on a surface of the display screen 116. For some embodiments, the one or more touch sensors 130 may include capacitive sensors that can sense or detect a human body's capacitance as input. In the example of FIG. 1, the touch-sensing region coincides with a substantial surface area, if not all, of the display screen 116. Yet further, an interaction received at the touch-sensing display screen 116 may coincide with the specific location of touch-sensors 130 involved thereon.

In some embodiments, the e-reading device 110 includes features for providing functionality related to displaying paginated content. The e-reading device 110 can include page transitioning logic 115, which enables the user to transition through paginated content. The e-reading device 110 can display pages from e-books, and enable the user to transition from one page state to another. In particular, an e-book can provide content that is rendered sequentially in pages, and the e-book can display page states in the form of single pages, multiple pages or portions thereof. Accordingly, a given page state can coincide with, for example, a single page, or two or more pages displayed at once. The page transitioning logic 115 can operate to enable the user to transition from a given page state to another page state. In some implementations, the page transitioning logic 115 enables single page transitions, chapter transitions, or cluster transitions (multiple pages at one time).

The page transitioning logic 115 can be responsive to various kinds of interfaces and actions in order to enable page transitioning. In one implementation, the user can signal a page transition event to transition page states by, for example, interacting with the touch-sensing region of the display screen 116. For example, the user may swipe the surface of the display screen 116 in a particular direction (e.g., up, down, left, or right) to indicate a sequential direction of a page transition. In variations, the user can specify different kinds of page transitioning input (e.g., single page turns, multiple page turns, chapter turns, etc.) through different kinds of input. Additionally, the page turn input of the user can be provided with a magnitude to indicate a magnitude (e.g., number of pages) in the transition of the page state. For example, a user can touch and hold the surface of the display screen 116 in order to cause a cluster or chapter page state transition, while a tap in the same region can effect a single page state transition (e.g., from one page to the next in sequence). In another example, a user can specify page turns of different kinds or magnitudes through single taps, sequenced taps or patterned taps on the touch sensing region of the display screen 116.

According to some embodiments, the e-reading device 110 includes display sensor logic 135 to detect and interpret user input or user input commands made through interaction with the touch sensors 130. By way of example, the display sensor logic 135 can detect a user making contact with the touch-sensing region of the display screen 116. More specifically, the display sensor logic 135 can detect taps, an initial tap held in sustained contact or proximity with display screen 116 (otherwise known as a “long press”), multiple taps, and/or swiping gesture actions made through user interaction with the touch sensing region of the display screen 116. Furthermore, the display sensor logic 135 can interpret such interactions in a variety of ways. For example, each interaction may be interpreted as a particular type of user input corresponding with a change in state of the display 116.

For some embodiments, the display sensor logic 135 may further detect the presence of water, dirt, debris, and/or other extraneous objects on the surface of the display 116. For example, the display sensor logic 135 may be integrated with a water-sensitive switch (e.g., such as an optical rain sensor) to detect an accumulation of water on the surface of the display 116.

E-reading device 110 further includes extraneous object detection (EOD) logic 119, which in conjunction with display sensor logic 135, may operate to for detect the presence of water (and/or other extraneous objects) on the surface of the display 116. More specifically, the EOD logic 119 may determine that water is present on the surface of the display 116 based on detected interactions with the touch sensors 130. EOD logic 119 may determine that water is present on the display 116 based on a number of touch-based interactions detected via particular ones of touch sensors 130 and/or a contact duration (e.g., a length of time for which contact is maintained with a corresponding touch sensor 240) associated with each interaction. In variations, EOD logic 119 can detect other forms of extraneous objects such as dirt and debris.

For some embodiments, e-reading device 110 further includes extraneous object notification (EON) logic 137 for appropriately notifying the observer at e-reading device 110 in response to detecting the presence of water and/or other extraneous objects on the surface of the display 116. For example, EON logic 137 may configure the e-reading device 110 to display appropriate notification when water and/or other extraneous objects are present (e.g., “splashed”) on the surface of the display 116. More specifically, the EON logic 137 may perform one or more operations to mitigate or overcome the presence of extraneous objects (e.g., such as water) on the surface of the display 116. Accordingly, the EON logic 137 may be activated by the display sensor logic 135 upon detecting the presence of extraneous objects on the surface of the display 116.

One or more embodiments of EON logic 137 and EOD logic 119 as described herein may be implemented by computing device 110 using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments of EON logic 137 and EOD logic 119 as described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

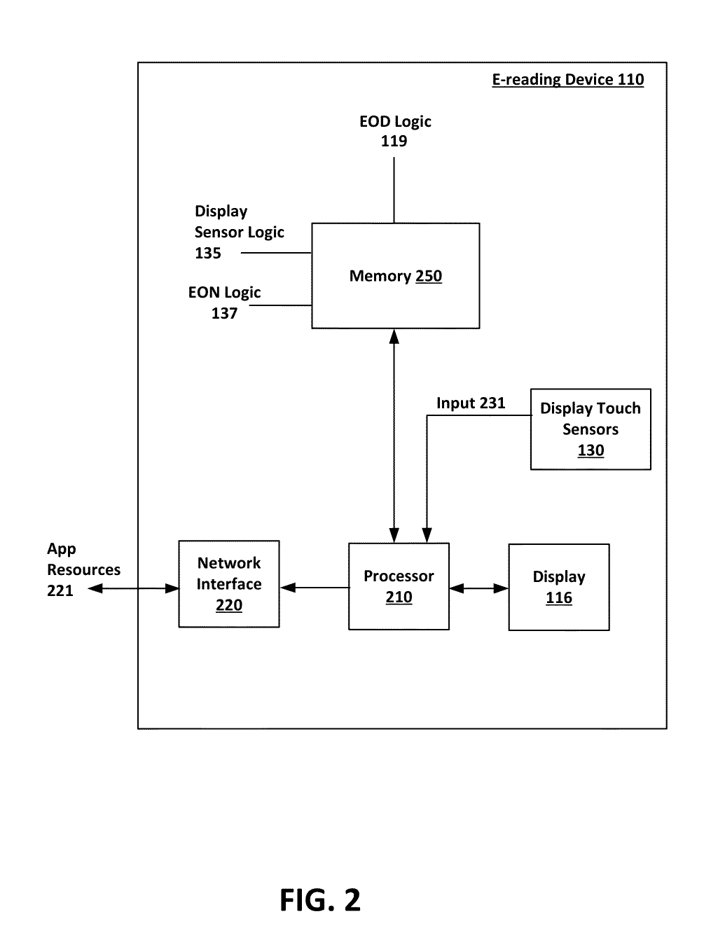

FIG. 2 illustrates a schematic architecture, in one embodiment, of e-reading device 110 as described above with respect to FIG. 1. With reference to FIG. 2, e-reading device 110 further includes a processor 210, a memory 250 storing instructions and logic pertaining at least to display sensor logic 135, EOD logic 119 and EON logic 137.

The processor 210 can implement functionality using the logic and instructions stored in the memory 250. Additionally, in some implementations, the processor 210 utilizes the network interface 220 to communicate with the network service 120 (see FIG. 1). More specifically, the e-reading device 110 can access the network service 120 to receive various kinds of resources (e.g., digital content items such as e-books, configuration files, account information), as well as to provide information (e.g., user account information, service requests etc.). For example, e-reading device 110 can receive application resources 221, such as e-books or media files, that the user elects to purchase or otherwise download via the network service 120. The application resources 221 that are downloaded onto the e-reading device 110 may be stored in the memory 250.

In some implementations, the display 116 can correspond to, for example, a liquid crystal display (LCD) or light emitting diode (LED) display that illuminates in order to provide content generated from processor 210. In some implementations, the display 116 can be touch-sensitive. For example, in some embodiments, one or more of the touch sensor components 130 may be integrated with the display 116. In other embodiments, the touch sensor components 130 may be provided (e.g., as a layer) above or below the display 116 such that individual touch sensor components 116 track different regions of the display 116. Further, in some variations, the display 116 can correspond to an electronic paper type display, which mimics conventional paper in the manner in which content is displayed. Examples of such display technologies include electrophoretic displays, electro-wetting displays, and electro-fluidic displays.

The processor 210 can receive input from various sources, including the touch sensor components 130 of display 116 and/or other input mechanisms (e.g., buttons, keyboard, mouse, microphone, etc.). With reference to examples described herein, the processor 210 can respond to input 231 detected at display touch sensors 130. In some embodiments, the processor 210 responds to inputs 231 in order to facilitate or enhance e-book activities such as generating e-book content on the display 116, performing page transitions of the displayed e-book content, powering on or off device 110 and/or display 116, activating a screen saver, launching or closing an application, and/or otherwise altering a state of the display 116, such as rendering a notification interface thereon.

In some embodiments, the memory 250 may store display sensor logic 135 that monitors for user interactions detected through the touch sensor components 130 of display screen 135, and further processes the user interactions as a particular input or type of input. In an alternative embodiment, the display sensor logic 135 may be integrated with the touch sensor components 130. For example, the touch sensor components 130 can be provided as a modular component that includes integrated circuits or other hardware logic, and such resources can provide some or all of the display sensor logic 135. In variations, some or all of the display sensor logic 135 may be implemented with the processor 210 (which utilizes instructions stored in the memory 250), or with an alternative processing resource.

Still with reference to FIG. 2 and the examples described herein, in a particular embodiment, display sensor logic 135 may interpret simultaneous contact with multiple touch sensors 130 as a type of non-user input. For example, the multi-sensor contact may be provided, in part, by water and/or other unwanted or extraneous objects (e.g., dirt, debris, etc.) interacting with the touch sensors 130. Processor 210 of e-reading device 110 may then infer, that, based on the multi-sensor contact, that at least a portion of the multi-sensor contact is attributable to presence of water droplets, splashes and/or other extraneous objects on the surface of the display 116.

For some embodiments, the display sensor logic 135 may detect the presence of water and/or other extraneous objects, including debris and dirt, on the surface of the display 116. For example, the display sensor logic 135 may determine that extraneous objects are present on the surface of the display 116 based on a number of touch-based interactions detected via the touch sensors 130 and/or a contact duration (e.g., a length of time for which contact is maintained with a corresponding touch sensor 130) associated with each interaction. More specifically, the display sensor logic 135 may detect the presence of water and/or other extraneous objects if a detected interaction falls outside a set of known gestures (e.g., gestures that are recognized by the e-reading device 110). Such embodiments are discussed in greater detail, for example, in co-pending U.S. patent application Ser. No. 14/498,661, titled “Method and System for Sensing Water, Debris or Other Extraneous Objects on a Display Screen,” filed September 26, 2014, which is hereby incorporated by reference in its entirety.

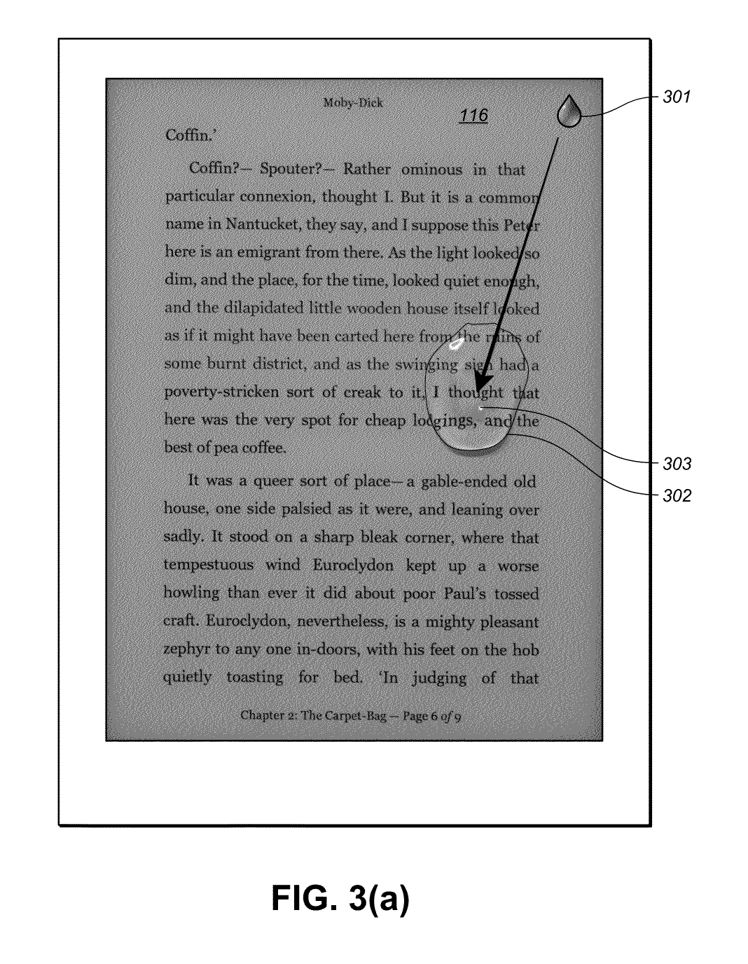

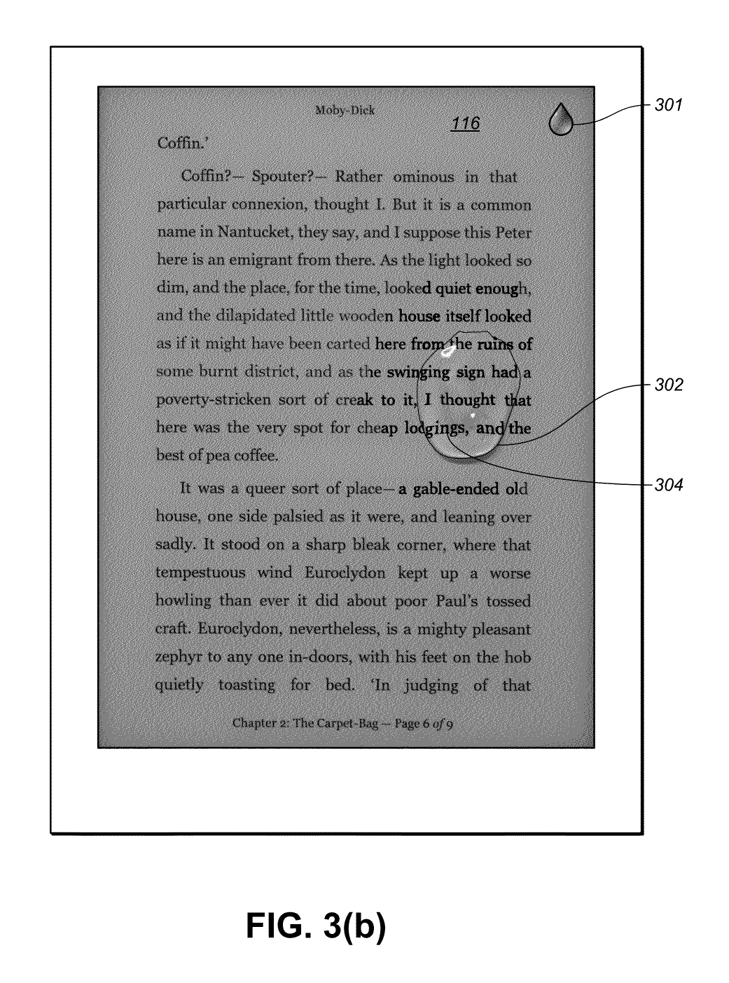

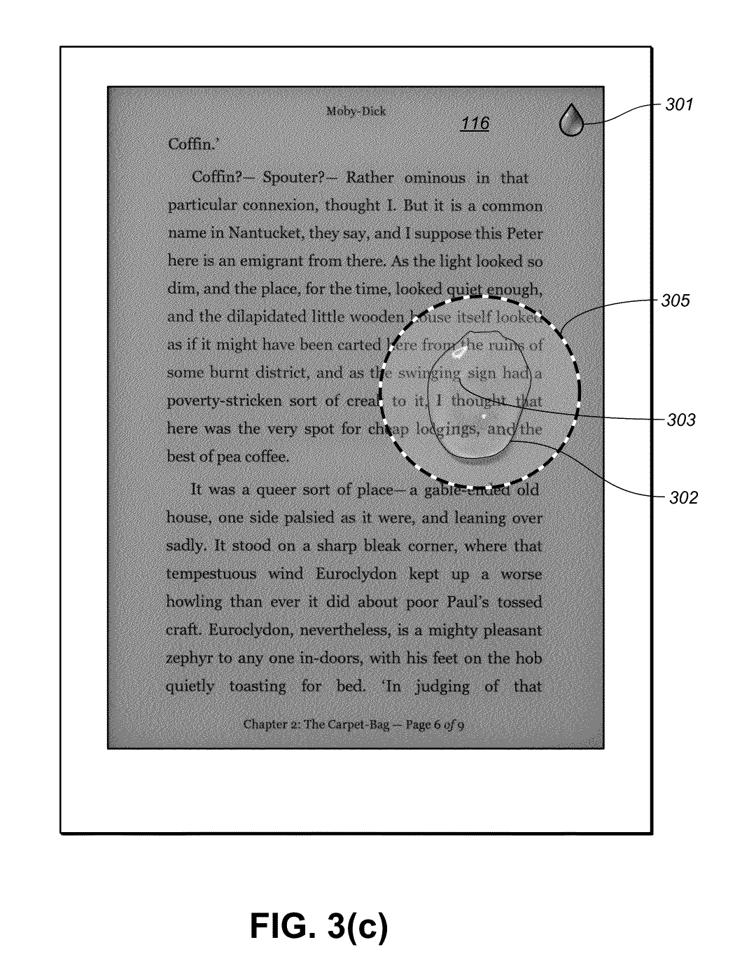

With reference now to FIG. 3(a) and FIG. 3(b), a droplet of water having a spatial area bounded by perimeter 302 may be detected as present on the display screen 116. It should be noted that water droplet having perimeter 302 may interact with one or more touch sensors 130 of display screen 116 and may comprise an interaction since it represents a single continuous object having spatial area bounded by perimeter 302, overlaying displayed text content portion 303. The underlying text portion content portion 303 may be a part of a larger text content portion rendered on display screen 116, for instance, a single page of paginated e-book content in which the text content comprises alpha-numerical and/or symbol characters having text attributes such as a particular font size or a font type (italics, boldface, etc.). The e-reading device 110 may activate a water-sensing timer upon detecting the presence of both the droplet 302 on the touch-sensing region of display screen 116. For example, the water-sensing timer may then count down (e.g., for a predetermined duration) for as long as the droplet 302 remains in contact with the touch-sensing region 116. Once the water sensing timer times out (e.g., the countdown reaches zero), processor 210 of e-reading device 110, operating in conjunction with EOD logic 119, may infer that presence of a water droplet has rendered display screen 116 wet.

Still with reference to FIGS. 3(a) and 3(b), in one embodiment, upon inferring presence of the water droplet, a wet mode indicator icon 301 may be rendered upon display screen 116 as a first notification aspect provided by EON logic 137. In another notification aspect, underlying text content portion 303 may be rendered visually differently to contrast with displayed text of the larger text content being shown on display screen 116. In one embodiment, text characters of underlying text content portion 303 may be rendered according to a different font size or font type. In another variation, the text characters of underlying text content portion 303 may be rendered in a distorted manner as depicted in FIG. 3(a), whereby they no longer conform to uniformity of font size, type and font shape, as compared to surrounding text characters. In other variations, it is contemplated that underlying text content portion 303 and/or perimeter 302 may be rendered according to different colors and/or illuminations, or even via pulsating or other visual aspects, in distinction to the remainder of the larger text content portion shown on display screen 116.

FIG. 3(c) shows a further embodiment at least one further boundary 305 can be rendered generally concentric with water droplet perimeter 302, for providing notification in an unobtrusive manner to an observer at e-reading device 110, as compared to a pop-up notification interface which may interrupt the observer's reading experience by necessitating user input.

### Methodology

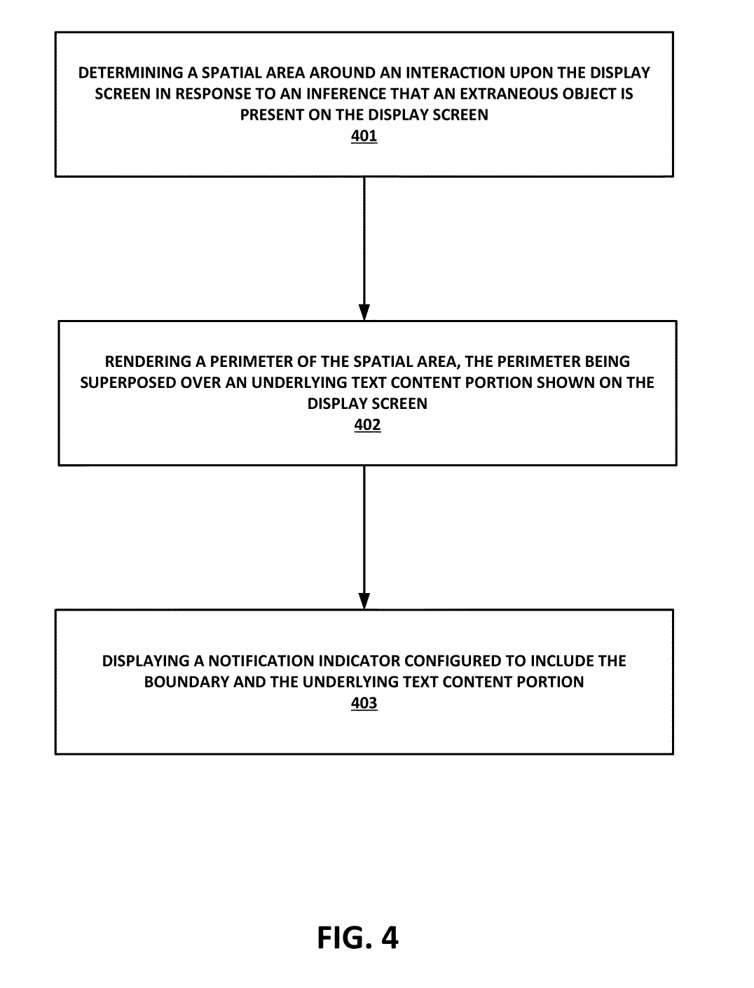

FIG. 4 illustrates a method of operating an e-reading device 110 to provide a notification indicator when water and/or other extraneous objects are present on the display 116, according to one or more embodiments. In describing the examples of FIG. 4, reference may be made to components such as described with FIGS. 1, 2 and 3(a)-(c), for purposes of illustrating suitable components and logic modules for performing a step or sub-step being described.

With reference to the example of FIGS. 3(a)-(c), the e-reading device 110 may detect the presence of one or more extraneous objects on a surface of the display 116 (610). For some embodiments, the display sensor logic 135 may detect the presence of extraneous objects on the surface of the display 116 based on a number of touch-based interactions detected via the touch sensors 130 and/or a contact duration associated with each of the interactions. For example, the display sensor logic 135 may determine that extraneous objects are present on the surface of the display 116 if a detected interaction falls outside a set of known gestures.

At step 401, determining a spatial area around the at least one interaction in response to an inference that an extraneous object is present on the display screen 116 at the computing device 110.

At step 402, rendering a perimeter 302 of the spatial area, the perimeter being superposed over an underlying text content portion 303 shown on the display screen 116, at computing device 110.

At step 403, displaying a notification indicator configured to include the boundary 302 and the underlying text content portion 303.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments.

What is claimed is:

1. A method executed in a processor of a computing device, the computing device including a memory storing instructions, a display screen including a set of touch sensors, the processor capable of inferring a presence of an extraneous object on the display screen based on an at least one interaction with the set of touch sensors, the method comprising:
determining a spatial area around the at least one interaction in response to an inference that an extraneous object is present on the display screen;
rendering a perimeter of the spatial area, the perimeter being superposed over an underlying text content portion shown on the display screen; and
displaying a notification indicator configured to include the boundary and the underlying text content portion.

2. The method of claim 1, wherein the perimeter is rendered to portray one of a water droplet and a water splash.

3. The method of claim 1 wherein the notification indicator further comprises at least one boundary rendered outside the perimeter and generally concentric therewith.

4. The method of claim 1 wherein the underlying text content portion is a part of a larger text content portion rendered on the display screen, the text content portions comprising text characters rendered in one of a font size and a font type.

5. The method of claim 4 wherein the notification indicator is configured to display the underlying text content portion in a different font size than a remainder of the larger text portion.

6. The method of claim 4 wherein the notification indicator is configured to display the underlying text content portion in a different font type than a remainder of the larger text portion.

7. The method of claim 4 wherein the notification indicator is configured to display the text characters of the underlying text content portion in a distorted fashion relative to the larger text content portion.

8. The method of claim 1, wherein the notification indicator is configured to display text characters of the underlying text content portion according to a different display screen brightness relative to a remainder of the larger text content portion.

9. The method of claim 1 wherein the notification indicator is configured to show the boundary in a color different from the larger text content portion.

10. The method of claim 1 wherein the notification indicator is configured to show the boundary according to a pulsating representation.

11. A computing device comprising:
a memory storing instructions;
a display screen including a set of touch sensors;
a processor capable of inferring a presence of an extraneous object on the display screen based on an interaction with the set of touch sensors, the processor operable in conjunction with the instructions to:
determine a spatial area around an interaction in response to an inference that an extraneous object is present on the display screen;
render a perimeter of the spatial area, the perimeter being superposed over an underlying text content portion shown on the display screen; and
display a notification indicator configured to include the boundary and the underlying text content portion.

12. The computing device of claim 11 wherein the perimeter is rendered to portray one of a water droplet and a water splash.

13. The computing device of claim 12 wherein the notification indicator further comprises at least one boundary rendered outside the perimeter and generally concentric therewith.

14. The computing device of claim 11 wherein the underlying text content portion is a part of a larger text content portion rendered on the display screen, the text content portions comprising text characters rendered in one of a font size and a font type.

15. The computing device of claim 14 wherein the notification indicator is configured to display the underlying text content portion in a different font size than a remainder of the larger text portion.

16. The computing device of claim 14 wherein the notification indicator is configured to display the underlying text content portion in a different font type than a remainder of the larger text portion.

17. The computing device of claim 14 wherein the notification indicator is configured to display the text characters of the underlying text content portion in a distorted fashion relative to the larger text content portion.

18. The computing device of claim 14 wherein the notification indicator is configured to display text characters of the underlying text content portion according to a different display screen brightness relative to a remainder of the larger text content portion.

19. The computing device of claim 14 wherein the notification indicator is configured to show the boundary in a color different from the larger text content portion.

20. The computing device of claim 14 wherein the notification indicator is configured to show the boundary according to a pulsating representation.

21. A non-transitory computer-readable medium storing instructions that, when executed by a processor of a computing device, cause the processor to perform operations that include:
determining a spatial area around an interaction in response to an inference that an extraneous object is present on the display screen;
rendering a perimeter of the spatial area, the perimeter being superposed over an underlying text content portion shown on the display screen; and
displaying a notification indicator configured to include the boundary and the underlying text content portion.
